(19) United States
(12) Patent Application Publication
(10) Pub. No.: US 2013/0126295 A1
(43) Pub. Date: May 23, 2013

(54) COIN COMPOSITION AND METHOD OF MANUFACTURING THE SAME

(71) Applicant: Raymond F. Decker, Ann Arbor, MI (US)

(72) Inventor: Raymond F. Decker, Ann Arbor, MI (US)

(21) Appl. No.: 13/679,408

(22) Filed: Nov. 16, 2012

Related U.S. Application Data
(60) Provisional application No. 61/561,549, filed on Nov. 18, 2011.

(51) Int. Cl. G07F 1/06

(52) U.S. Cl. CPC G07F 1/06
USPC 194/214; 427/229

(57) ABSTRACT

A currency coin and method of making a currency coin. The currency coin includes a planchet coated with Ni derived from carbonyl Ni. During production of the currency coin, a planchet of one a variety of materials is provided and Ni is derived from Ni containing material utilizing the carbonyl process. In short, Ni is derived from carbonyl Ni. The Ni derived from carbonyl Ni is then deposited on the planchet forming a Ni coated coin.

### CROSS REFERENCE TO RELATED APPLICATIONS

The present application claims priority to U.S. provisional application entitled COIN COMPOSITION AND METHOD OF MANUFACTURING THE SAME having Ser. No. 61/561,549 and filed on Nov. 18, 2011, the entire contents of which is hereby incorporated by reference.

### BACKGROUND

1. Field of the Invention

The present invention generally relates to the field of currency. More specifically, the invention relates to a new coin construction and composition, as well as a method of manufacturing the same.

2. Description of Related Technology

Coins have always been a widely used type of currency. In many instances, coins are preferred over paper money because of the durability and longevity of the coins. However, the cost of producing coins has been increasing.

One widely used type of U.S. coin is the nickel. The current nickel coin is monolithic and composed of 75% copper (Cu) and 25% nickel (Ni). (In order to avoid confusion, hereafter the metal nickel is referred to by its element symbol “Ni” and the nickel coin is merely referred to as “nickel.”)

Over the last 20 years, the tenfold increase in the cost of alloying elements, such as Cu and Ni, has resulted in alloying and production costs that are greater than the actual coinage values (this is generally known as negative seigniorage). The volatile pricing and speculation of primary Ni and Cu on the London Metal Exchange has exacerbated this problem. Thus, a nickel that can be constructed and manufactured so as to exhibit a positive seigniorage is desired.

### DETAILED DESCRIPTION

With the present invention, a coin construction and composition is conceived such that a nickel that can be manufactured so as to exhibit a positive seigniorage. Specifically, the carbonyl process serves this purpose by both extracting Ni from inexpensive sources and by utilizing the extractant as a thin, durable Ni coating applied on an inexpensive base metal. Thus, low-cost nickels, ones that have and match the unique coin signature required in a coin operated machine, while also being difficult to counterfeit, can be produced. Regarding the signature of the coin, it is conceived that the signature of the coin can be tuned so as to be acceptable in current coin operated machines by alloying the Ni coating by co-depositing such elements as chromium (Cr), silicon (Si), molybdenum (Mo), tungsten (W) and vanadium (V), to decrease the magnetic permeability of the nickel. Furthermore, the coinability, hardness, wear resistance and corrosion resistance of the Ni coating can be modified by co-depositing elements such as boron (B), Silicon (Si), phosphorus (P) and Cr.

### The Carbonyl Process

The carbonyl process was discovered in late 1880's by Ludwig Mond, and has been practiced commercially since the start of the 1900's. The carbonyl process is a technique originally created to extract and purify Ni. This is done by converting Ni oxides (Ni combined with oxygen (O)) into pure Ni. The reaction Ni+4(CO)<====>Ni(CO)₄ is unique and reversible. In one direction, the reaction with excess carbon monoxide (CO) serves to convert Ni to a liquid carbonyl, Ni(CO)₄, at temperatures near ambient (40-75° C.). Ni(CO)₄ is referred to as carbonyl Ni. In the reverse reaction, when the liquid carbonyl is heated to 175-250° C., the carbonyl decomposes to produce pure Ni, which, during the process, can be manipulated so as to form a deposit on a substrate. Thus, uniform coatings ranging from 1 micron up to 25 mm are feasible. With practical coating deposition rates, coatings of about 10 microns can be achieved in about 4 minutes. As used herein, a carbonyl Ni coated planchet or substrate is a planchet or substrate coated with Ni derived from carbonyl Ni.

While Ni and iron (Fe) are the most amenable for carbonyl processing, Mo, W, Cr, cobalt (Co) and manganese (Mn) carbonyls can be synthesized.

Some features of commercial facilities utilizing the carbonyl process are the following:
1. Low operating costs;
2. Savings of costs by using low-cost Ni sources;
3. Environmentally friendly monitored plants;
4. Tough safety standards;
5. Automation;
6. No liquid wastes, all solid wastes have value;
7. Low maintenance costs;
8. Low energy costs;
9. Low reagent costs (CO can be recycled); and
10. Flexible (agile) modular plant design.

### Coin Machines and Eddy Currents

Coin machines are tuned to generate eddy currents as the inserted coin progress down the entry ramp. An electromagnet is used to slow the progression of the coin. With a monolithic coin, the eddy current power (P_{ec}) determines the slowing response of the coin and is a function of resistivity and density according to the following relationship, where (p) is resistivity and (D) is density:

P_{ec}≅1/ρD (Eq. 1)

Thus, one can increase the slowing of a coin in a coin machine by decreasing the resistivity and density of the coin material. However, when a magnetic material is used in a coating, a skin effect is imposed. As a result, the penetration depth (δ) and eddy current power (P_{ec}) is diminished as a function of magnetic permeability (μ) and resistivity (ρ) of the magnetic coating and the frequency (f) of the magnetic field, as follows:

δ≅1/√(πfμρ⁻¹) (Eq. 2)

Thus, one can increase the speed of the coin in the machine by adjusting the depth of penetration of the eddy currents, which is achieved by increasing the magnetic permeability and decreasing resistivity of the coating, while increasing the frequency of the magnetic field of the coin machine device.

### Coins—Properties Needed

From the above, as well as from other criteria, it is seen that the critical properties required in a coin are as follows:
A. Density (D);
B. Resistivity (ρ);
C. Magnetic permeability (μ);
D. Hardness—to resist wear;
E. Corrosion resistance—to environmental factors, including human contact;
F. Coinability—to permit sharp facial images, with minimum wear on coining dies

### Effect of Alloying on Physical Properties

TABLE I
Physical Properties of Coinage Materials

| | | Resistivity, ρ | |
|---|---|---|---|
| Element/Alloy | Density, D (g/cc) | (nΩm) | Permeability, μ |
| Ni | 8.90 | 68.44 | 1.25 × 10⁻⁴ |
| Fe | 7.87 | 100 | 8.75 × 10⁻⁴ |
| Zn | 7.17 | 63.1 | 1.26 × 10⁻⁶ |
| Al | 2.66 | 59.5 | 1.26 × 10⁻⁶ |
| Cu | 8.94 | 17.1 | 1.26 × 10⁻⁶ |
| 75 Cu/25 Ni | 8.94 | 320 | 1.26 × 10⁻⁶ |
| 80 Ni/20 Cr | 8.37 | 1090 | 1.26 × 10⁻⁶ |

### Costs

As noted above, the intrinsic value of the coin should be significantly lower than the face value (positive seigniorage) of the coin. This provides a profit to the minting authority and provides a hedge, or insurance, against future increases in costs of the materials for the coin. For example, the U.S. nickel, which has a 5¢ face value, currently has negative seigniorage. This means that the face value of the nickel is less than the production costs, including the cost of the needed metals, Ni and Cu. The current situation is further exacerbated by the volatility of prices on the London Metal Exchange (LME), the exchange on which metal futures are traded. The inventor of the present invention has developed candidate replacement elements, which are of lower cost, and these are listed below in Table II.

TABLE II
Current Cost of Metals for Coins

| Metal | Cost, $/lb |
|---|---|
| Ni | 12.00 |
| Cu | 4.00 |
| Zn (zinc) | 1.10 |
| Fe (iron) | 0.25 |
| Al (aluminum) | 1.00 |

With the present invention, a major reduction in the costs of coins, which is being illustrated herein with reference to the U.S. nickel, can be achieved. Currently, the nickel is monolithic structure composed 75% Cu and 25% Ni. Current projections are for 1,000,000,000 nickel coins p.a. These coins would contain 2,500,000 lbs. of Ni (at a cost of $30,000,000) and 7,500,000 lbs. of Cu (at cost of $30,000,000), for an annual total cost of $60,000,000 being incurred by the U.S. Mint. Replacing this nickel coin with one having a 10 μm carbonyl Ni coated Zn substrate would entail costs of $1,200,000 for Ni and $10,890,000 for Zn, for an annual total cost of $12,090,000. This translates to an annual cost saving of $47,910,000.

If an Fe planchet replaced the Zn planchet in the above example, the saving would be even greater. For a nickel coin constructed as a carbonyl Ni coated Fe substrate, the annual Fe cost would be $2,475,000 and the total annual nickel coin cost would be $3,675,000. This results in an annual savings of $56,325,000.

An additional savings for a minting authority, could accrue from carbonyl recycling of 50, 100, 250 and 500 coins being withdrawn from circulation, all of which include Ni, as well as from scrap material containing Ni and Cu therein.

### Physical Properties (μ, D, ρ)

To match the physical properties of the 75 Cu/25 Ni alloy now used in the U.S. nickel, Fe is too high in its magnetic permeability, Zn is low in its resistivity, Cu is too low on resistivity and Al is low on resistivity and density (see Table II). Ni is too low on resistivity and too high on permeability. A composite approach is needed to match the signature of the nickel for coin machines. However, a thin coating of carbonyl Ni or alloyed carbonyl Ni on a Zn or Cu substrate can be produced to match the combination of the three desired physical properties. Minor additions of Si and/or Cr to the Ni, to increase the magnetic permeability and decrease the permeability, has been discovered as one means to this end.

### Wear and Coinability

Monolithic coins based on Zn and Al lack the needed hardness for good wear service. Low carbon steels (<0.01 C), however, are suitable for both wear and coinability. While Ni by itself may be suitable for wear considerations and coinability, minor alloying additions, such as B, Si, Cr and P, are conceived as improving both the wear resistance and coinability of carbonyl Ni.

### Corrosion and Appearance

None of the replacement substrate elements mentioned above (Fe, Zn, Al) alone have the requisite corrosion resistance to human contact, i.e. human sweat. Without a coating, Fe will rust and turn red; Zn will turn a dark grey; and Al will dull in appearance. Accordingly, a protective coating on these substrate candidates would be needed; Ni is one such material for the protective coating. Furthermore, the medical profession has previously expressed concern regarding possible accidental ingestion of various coins. These concerns arise because possible links between certain metal and certain diseases. For example, some scientific analysis has indicated that there may be a possible link between Al and both dementia and Alzheimer's disease. This link, however, has not been definitively concluded.

### Production Considerations

It is desirable that any replacement coin would be susceptible to and compatible with the coining and finishing operations and the extant production equipment at the various minting authorities. For this reason, the hardness of the substrate metal should be neither too soft, nor too hard, for blanking and subsequent coining with current equipment. It is also preferable to avoid any annealing steps since this adds to the time and cost of production.

As to plant capacity for the carbonyl Ni process, a 10 μm Ni coating on 1,000,000,000 nickel planchets annually would require 50 tons of carbonyl Ni. This amount of carbonyl Ni is well within the production capacity of known commercial plants. Production costs in these plants are also well below the costs of alternate electro-deposition processes. Also, carbonyl Ni coatings solve the residual stress problem inherent in the electro-deposition of Ni on Zn, a problem that precludes the latter process in commercial production. A new production plants would further promote the technology, as well as add to local production jobs to the economy. Alloying of carbonyl Ni coatings could result from engineered additions to the gas phase of the process, such as with the addition of silane or borane.

### Illustrative Coin Concepts and Examples

In one illustrative embodiment incorporating the principles of the present invention, a proposed replacement nickel includes a Zn alloy planchet that is coated with a thin carbonyl Ni alloy layer. This combination of Zn substrate and carbonyl Ni coating further matches the coin machine signature of the current nickel, which is a function of μ, D and ρ. Alloying of the Ni layer can be varied to moderate the magnetic permeability, μ, of the resultant coin. The Ni layer would retain enough magnetic permeability to decrease the depth of eddy current penetration in the coin, thus compensating for the difference in ρ and D from the current 75Cu/25Ni composition.

A process incorporating the principles of the present invention would, in one embodiment, include the extraction of carbonyl Ni from low-cost Ni intermediates, followed by carbonyl deposition on the planchets/substrates. The carbonyl Ni deposit being tailored for μ, D and ρ by co-deposition of elements that modify hardness as well as μ, D and ρ. It is anticipated that this could save significant p.a. expenses for minting authorities, for example, up to $47,000,000 p.a. for the U.S. Mint.

In another embodiment of the present invention, a coin having a carbonyl Ni coating on a steel planchet is provided. Such a construction would anticipatorily save approximately $56,325,000 p.a. for the U.S. Mint, with similarly large savings for other minting authorities. Such a coin would be magnetic and would therefore require modification of coin machines where that characteristic would interfere with operation of the coin machine.

In another embodiment of the invention, a carbonyl Ni coated Zn coin is provided to match the signature of a coin containing a Cu core, such as a U.S. dime, quarter or fifty-cent piece.

Further examples of contemplated coin constructions for the coating and planchet and embodying the principles of the present invention include the following, without limitation: carbonyl Ni coated Zn alloy 190; carbonyl Ni coated low carbon EDDS steel; carbonyl Ni with 2-5% Si, coated on Zn alloy 190; a coin having an intermediate magnetic permeability of a Ni layer of 1−5×10⁻⁵ matching the signature of current 75 Cu/25 Ni coins; carbonyl Ni with 0.01-0.10% B coated on EDDS steel; and carbonyl Ni with 0.01-0.10% B, coated on Zn alloy 190.

Further examples of processes for the manufacturing of a coin in accordance with the teachings of the present invention include, without limitation, the following: extracting Ni by CO from Ni matte; extracting Ni by CO from Ni carbonate; extracting Ni by CO from Ni oxide; extracting Ni by CO from Cu/Ni scrap from punched coinage scrap; extracting Ni by CO from used Cu/Ni coins; extracting Ni by CO from lateritic Ni ore derivatives; extracting Ni by CO from sulfide Ni ore derivatives; extracting Ni by CO from spent Ni catalysts; extracting Ni by CO from Ni containing radioactive elements from nuclear process plants; extracting Ni by CO by pressure CO treatment; the deposition of carbonyl Ni/Si from mixed Ni carbonyl/Silane gasses; the deposition of carbonyl Ni/B from mixed Ni carbonyl/Borane gasses; the deposition of carbonyl Ni/Mo from mixed Ni carbonyl/Mo carbonyl gasses; and the deposition of carbonyl Ni/Cr from mixed Ni carbonyl/Cr carbonyl gasses.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I claim:

1. A currency coin comprising a planchet coated with Ni derived from carbonyl Ni.

2. The coin of claim 1 wherein the planchet is formed of Zn.

3. The coin of claim 1 wherein the planchet is formed of a Zn alloy.

4. The coin of claim 3 wherein the Ni derived from carbonyl Ni is alloyed with Cr and has increased resistivity and decreased permeability relative to the same coin not alloyed with Cr.

5. The coin of claim 3 wherein the carbonyl Ni derived from carbonyl Ni is alloyed with Si and has increased resistivity and decreased permeability relative to the same coin not alloyed with Si.

6. The coin of claim 1 wherein the coin has a coin signature substantially similar to a 75 Cu/25 Ni U.S. nickel.

7. The coin of claim 1 wherein the planchet is formed of Fe.

8. The coin of claim 1 wherein the planchet is formed of Fe alloy.

9. The coin of claim 1 wherein the planchet is formed of Cu

10. The coin of claim 1 wherein the planchet is one formed of Cu alloy.

11. The coin of claim 1 wherein the Ni derived from carbonyl Ni is alloyed with Cr.

12. The coin of claim 1 wherein the Ni derived from carbonyl Ni is alloyed with Si.

13. The coin of claim 1 wherein the Ni derived from carbonyl Ni is alloyed with P.

14. The coin of claim 1 wherein the Ni derived from carbonyl Ni is alloyed with B.

15. A method for the production of coins, the method comprising the steps of:
providing a planchet; and
deriving Ni from carbonyl Ni; and
depositing Ni on the planchet,
whereby a Ni coated coin is formed.

16. The method of claim 15 wherein the planchet is one of Zn and Zn alloy and the planchet is passed through a decomposer employing a carbonyl process whereby Ni is deposited on the planchet.

17. The method of claim 15 wherein the planchet is one of Fe and Fe alloy and the planchet is passed through a decomposer employing a carbonyl process whereby Ni is deposited on the planchet.

18. The method of claim 15 wherein the planchet is one of Cu and Cu alloy and the planchet is passed through a decomposer employing a carbonyl process whereby Ni is deposited on the planchet.

19. The method of claim 15 wherein the planchet is one of EDDS Steel and Zn Alloy 190.

20. The method of claim 15 wherein Ni derived from carbonyl Ni is alloyed with one of Cr, Si, P and B.
